(19) United States
(12) Patent Application Publication
(10) Pub. No.: US 2026/0318239 A1
(43) Pub. Date: Oct. 15, 2026

(54) SUPPORT PLATE FOR EXHAUST TUBE AND EXHAUST TUBE ASSEMBLY INCLUDING SAME

(71) Applicant: Caterpillar Inc., Peoria, IL (US)

(72) Inventors: Lance Clay Barke, Peoria, IL (US); Douglas T. Scott, Rapid City, SD (US); Andrew Michael Denis, Peoria, IL (US); Daniel R. Barb, East Peoria, IL (US)

(73) Assignee: Caterpillar Inc., Peoria, IL (US)

(21) Appl. No.: 19/175,516

(22) Filed: Apr. 10, 2025

(51) Int. Cl. F01N 3/28; B01D 53/94

(52) U.S. Cl. CPC F01N 3/2892; B01D 53/94; B01D 2258/01; B01D 2259/4566

(57) ABSTRACT

A support plate includes a first leg having a first foot, a second leg having a second foot, the first foot and the second foot extending outwardly, and a connector portion bridging the first leg and the second leg. The support plate body also includes an outer plate surface, a curvilinear inner plate surface extending between the first foot and the second foot, and a plurality of relief openings each extending along a part of a curve distance defined by the inner plate surface.

### TECHNICAL FIELD

The present disclosure relates generally to an exhaust system, and more particularly to a support plate designed to support an exhaust tube.

### BACKGROUND

Reduction in certain emissions from internal combustion engines has been of interest for many years. Combustion of a fuel and air within engine cylinders produces a variety of emissions, including carbon monoxide, carbon dioxide, particulate matter including soot and ash, unburned hydrocarbons, and oxides of nitrogen or “NOx.” Manufacturers of engines and related systems have devised a great many different strategies for limiting discharge especially of particulate matter and NOx.

With regard to particulate matter, it has become conventional to equip internal combustion engine systems with filtration equipment to trap particulates that would otherwise be discharged. Other components such as selective catalytic reduction (SCR) devices to limit NOx are used in aftertreatment systems, and some such equipment can make the overall exhaust system quite complex. While proven effective, there are certain challenges SCR devices encounter, particularly regarding the atomization and vaporization of diesel exhaust fluid (DEF). In various applications, such as where spatial constraints exist and continue to become more pronounced, achieving efficient and complete vaporization of DEF may be challenging. Increasingly stringent emissions regulations, as well as expected new and different future regulations have further compounded such challenges. One example exhaust aftertreatment strategy is known from WIPO Application No. WO2018/153162A1. While the concepts disclosed in this reference may work in certain applications, there is always room for improvement and development of alternative strategies

### SUMMARY

In one aspect, an exhaust system includes a housing, an exhaust tube forming an exhaust passage to receive a flow of exhaust, and a support plate supporting the exhaust tube in the housing. The support plate includes a first leg, a second leg, and a connector portion bridging the first leg and the second leg. The support plate also includes an inner plate surface attached to the exhaust tube, an outer plate surface attached to the housing, and a relief opening formed between the inner plate surface and the outer plate surface.

In another aspect, an exhaust tube assembly includes an exhaust tube having an exhaust inlet located in a first tube end, an exhaust outlet located in a second tube end, and an inner tube surface forming an exhaust passage to receive a flow of exhaust. The exhaust tube assembly also includes a support plate having a first leg, a second leg, and a connector portion bridging the first leg and the second leg. The support plate includes an outer plate surface, an inner plate surface, and a relief opening formed between the outer plate surface and the inner plate surface.

In yet another aspect, a support plate for an exhaust tube assembly includes a support plate body including a first leg connected to a first foot, a second leg connected to a second foot, the first foot and second foot extending outwardly from the respective legs, and a connector portion bridging the first leg and the second leg. The support plate body also includes an outer plate surface, a curvilinear inner plate surface extending between the first foot and the second foot, and a plurality of relief openings each extending along a part of a curve distance defined by the inner plate surface.

### BRIEF DESCRIPTION OF DRAWINGS

FIG. 1 is a schematic view of an internal combustion engine, according to one embodiment;

FIG. 2 is a perspective view of an exhaust module equipped with an exhaust tube assembly, according to one embodiment;

FIG. 3 is a sectioned view, in perspective, of portions of the exhaust module as in FIG. 2;

FIG. 4 is a perspective view of an exhaust tube assembly, according to one embodiment;

FIG. 5 is a perspective view of a support plate, according to one embodiment; and

FIG. 6 is a front view of a support plate, according to one embodiment.

### DETAILED DESCRIPTION

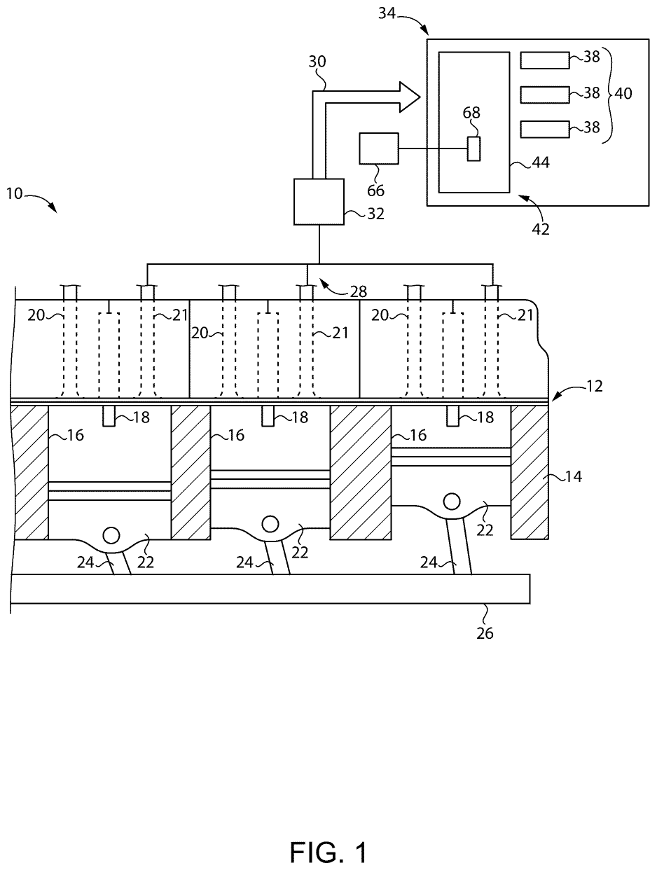

Referring to FIG. 1, there is shown an internal combustion engine system 10 (hereinafter “engine system 10”) according to one embodiment. Engine system 10 can be used in an off-highway machine such as a tractor, a truck, or an excavator, for example. Engine system 10 could also be implemented in an engine-generator set, a pump, a compressor, or still another machine such as an on-highway vehicle or a marine vessel. Engine system 10 includes an engine 12 having a cylinder block 14. Cylinder block 14 may include therein any number of cylinders 16 in any suitable arrangement. Engine 12 may also include a fuel injector 18 to deliver a fuel typically directly into cylinder 16, and an intake valve 20 to regulate a flow of air or an air and fuel mixture into cylinder 16. Engine 12 may also include an exhaust valve 21 for expelling exhaust gases following combustion of the air and fuel mixture. Engine 12 may include a plurality of fuel injectors 18 including, for example, direct fuel injectors each positioned to deliver fuel directly into individual cylinders 16. Port fuel injectors are also within the scope of the present disclosure. Intake valve 20 and exhaust valve 21 may each be one of a respective two intake and exhaust valves associated with each cylinder 16 in engine 12.

Engine 12 may be a compression-ignition engine including a plurality of pistons 22 movable in cylinder block 14 and structured to compress fluids in cylinders 16 to an autoignition threshold for a fuel, such as a liquid diesel distillate fuel, and air. The present disclosure is not thereby limited, however, and engine 12 could be spark-ignited, a dual fuel engine that is liquid pilot-ignited operating on both a liquid fuel and a gaseous fuel, or still another type. Engine system 10 may also include a connecting rod 24 which rotates a crankshaft 26 in response to reciprocation of pistons 22 in cylinders 16 in a generally conventional manner.

Engine system 10 further includes an exhaust system 28. Exhaust system 28 may include an exhaust conduit 30 extending from an exhaust manifold 32 to an exhaust module 34. Exhaust system 28 could also include a turbocharger having a compressor and a turbine (not shown) in a generally conventional manner. Exhaust system 28 can also include other aftertreatment equipment including, but not limited to, a particulate filter or “DPF,” a diesel oxidation catalyst or “DOC,” an ammonia oxidation catalyst or “AMOX,” and an exhaust stack or tail pipe structured to discharge exhaust treated in exhaust system 28. Exhaust system 28 may also be equipped with a variety of sensors such as temperature sensors, NOx sensors, pressure sensors, or still others in an electronic control system for operating exhaust system 28 and/or engine system 10, as further discussed herein.

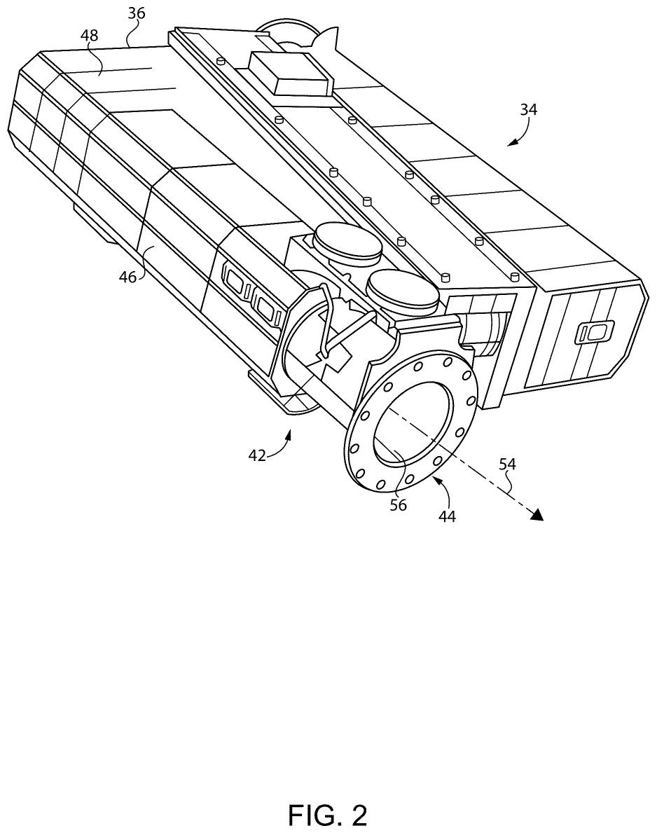

Also referring now to FIG. 2, exhaust module 34 may include an SCR module, sometimes referred to simply as an “SCR”, operable to reduce emissions of oxides of nitrogen (collectively “NOx”) by way of the introduction of a reductant, such as a urea liquid suspension, according to generally well-known principles. It should be appreciated that some or all of exhaust system 28 may be coupled to engine 12 and could be positioned in various locations relative to engine 12.

Exhaust module 34 may include a module housing 36 (hereafter “housing 36), having one or more catalyst bricks 38 resident therein, which can be strategically arranged within module housing 36 to form one or more catalyst banks 40. Catalyst bricks 38 could be formed from various materials such as ceramics, or other suitable substrates, coated with active catalytic agents such as precious metal catalysts, base metal catalysts, and combinations of these or still others. It should be understood that although described in the singular, “catalyst bank” is intended to include one or a plurality of catalyst banks.

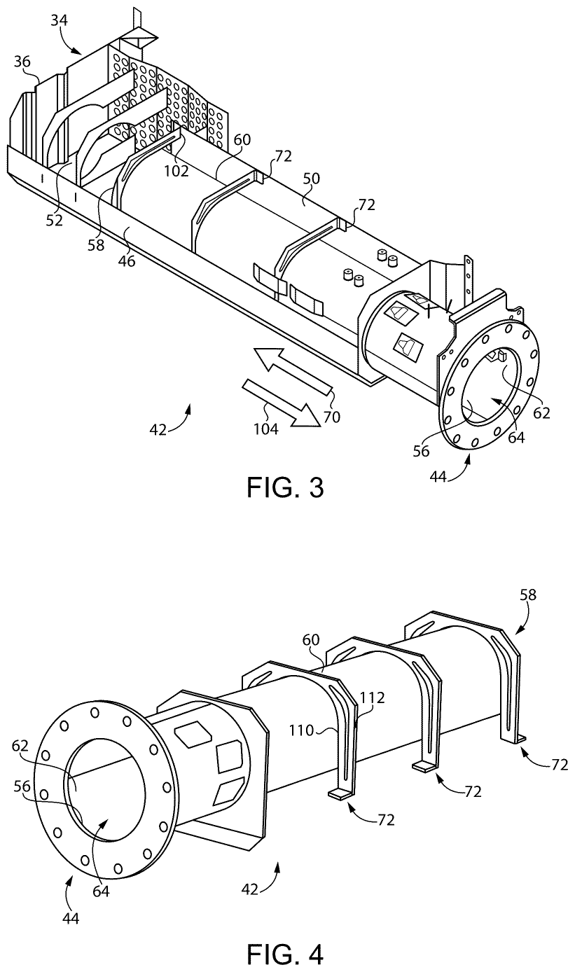

Exhaust system 28 may also include an exhaust tube assembly 42 having an exhaust tube 44. Also referring now to FIG. 3, module housing 36 may also include a first wall 46, a second wall 48, a third wall 50, and a fourth wall 52 providing a central area to accommodate exhaust tube 44. Exhaust tube 44 may be fluidly connected to catalyst bank 40 and may be wholly, or at least partially, located in module housing 36. Exhaust tube 44 defines a center axis 54 extending between an exhaust inlet 56 and an exhaust outlet 58. Exhaust tube 44 also includes an outer tube surface 60 and an inner tube surface 62 circumferentially extending around center axis 54 and forming an exhaust passage 64. Exhaust tube 44 could be, for instance, a mixing tube structured for mixing of exhaust and an injected fluid.

Exhaust system 28 may also include a reductant tank 66 for storing an on-board volume of a liquid reductant, such as a commercially available DEF, in a generally conventional manner. Description and discussion herein of “DEF” should not be understood to require any particular type of reductant. Exhaust tube 44 may also include a DEF injector 68, coupled to exhaust tube 44 and arranged to inject DEF into exhaust tube 44. DEF injector 68 may be oriented to inject DEF in a downstream direction 70 with a flow of exhaust, however, it should be appreciated that DEF injector 68 may be arranged to inject downstream, upstream, or still in another suitable direction.

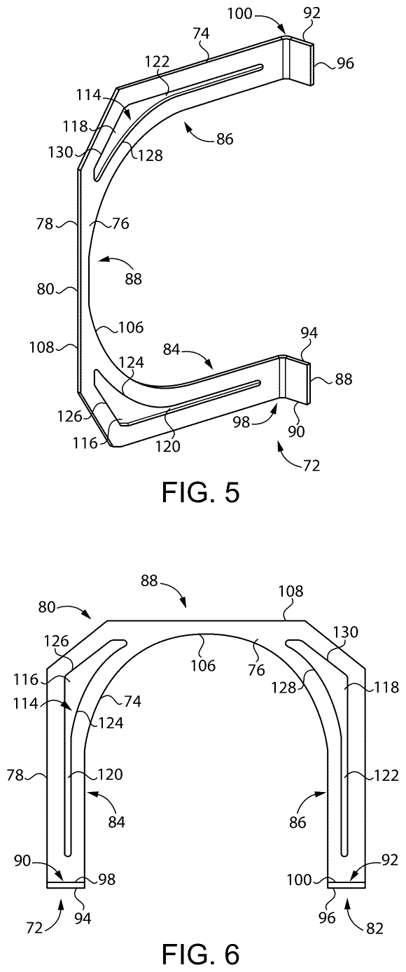

Referring also now to FIGS. 4-6, there are shown additional features of exhaust tube assembly 42. Exhaust tube assembly 42 may also include a support plate 72 designed to support exhaust tube 44 in housing 36. Support plate 72 may be fabricated from a metallic material, such as steel or aluminum, for example. Support plate 72 may include a support plate body 74. Support plate body 74 may form a shape that resembles a horseshoe or the letter “C”. Thus, in at least some embodiments support plate 72 can be understood to form a “horseshoe-shape” or a “C-shape”.

Support plate body 74 may include a first plate side 76 and a second plate side 78, extending between a first support plate end 80, and a second support plate end 82 located opposite to first support plate end 80. Support plate 72 may also include a first leg 84, a second leg 86, and a connector portion 88 bridging first leg 84 and second leg 86. Support plate 72 may also include a first foot 90 that is a part of and/or connected to first leg 84, and a second foot 92 that is a part of and/or connected to second leg 86. Both first foot 90 and second foot 92 may extend outwardly, away from first plate side 78 of support plate body 74. As illustrated, connector portion 88 is located at first plate end 80, and first foot 90 and second foot 92 are located at second plate end 82.

First foot 90 may include a first mounting surface 94, and second foot 92 may include a second mounting surface 96. First mounting surface 94 and second mounting surface 96 may be attached to housing 36. Various strategies could be utilized to attach first mounting surface 94 and second mounting surface 96 to housing 36, such as welding or brazing. First foot 90 may be connected to first leg 84 at a right-angle via a first corner joint 98, and similarly, second leg 86 may be connected to second foot 92 via a second corner joint 100. Support plate body 74 may be formed from a single piece of material such as by stamping, laser cutting, or the like.

In one practical example, support plate 72 may be one of a plurality of interchangeable support plates 72 attached to exhaust tube 44 and axially spaced along exhaust tube 44. In this example, both first foot 90 and second foot 92 of each support plate 72 could extend outwardly generally away from a downstream direction 70, although other orientations are contemplated. As shown in FIG. 3, for instance, one or more support plates 102 could include a first foot and a second foot extending away from an upstream direction 104. It should be understood that the configuration of each support plate 72 can vary depending on various factors, for example, the specific application, spatial constraints, or still other factors.

Support plate 72 may also include an inner plate surface 106 and an outer plate surface 108. Inner plate surface 106 may be located between first foot 90 and second foot 92, and is structured to attach to exhaust tube 44. Outer plate surface 108 may be attached to housing 36. Outer plate surface 108 may also slope diagonally from first leg 84 to connector portion 88, and may also slope diagonally from second leg 86 to connector portion 88. In a practical example, inner plate surface 106 may be a curvilinear inner plate surface extending around center axis 46. As can be seen in FIG. 4, inner plate surface 106 may be attached to outer tube surface 60 with a first weld 110. Outer plate surface 108 may be attached to housing 36 with a second weld 112. Put differently, outer plate surface 108 may be welded to first wall 46, second wall 48, and third wall 50. In this arrangement, first mounting surface 94 and second mounting surface 96 may attach first foot 90 and second foot 92 to fourth wall 52 via welding, fastening, or still through another attachment mechanism.

First weld 110 and second weld 112 may be displaced relative to one another based on temperature changes during service. As temperatures increase during operation of engine 12, exhaust tube 44 may elongate and first weld 110 could, for instance, translate relative to second weld 112. Thus, exhaust tube 44 may be subject to an increase in temperature during operation or use of engine system 10 which may lead to thermal expansion of the material from which exhaust tube 44 is formed. The increased temperature of engine system 10 may result in an increase in the overall dimensions of the exhaust tube 44 leading, absent mitigation, to damage to one of exhaust tube 44 or housing 36. Thermal expansion may, for example, cause exhaust tube 44 to elongate, bend, or otherwise change shape and/or size in a manner that could exert stress on any attached structure. Additionally, upon cooling down, exhaust tube 44 may contract, resulting in a reduction in the overall dimensions. Dimensional changes induced by heating and/or cooling may induce stress at contact points, create voids between attached components, or cause other challenges. In an example, locations of weld attachment points can vary relative to one another, potentially leading, absent mitigation, to material fatigue and/or weld failure or still other outcomes which may degrade overall performance of engine system 10.

To this end, support plate 72 may also include one or more relief openings 114, referred to at times herein in the singular, formed between inner plate surface 106 and outer plate surface 108 compensating for thermally induced dimensional changes of at least one of exhaust tube 44 or housing 36. Relief openings 114 may, for instance, be understood to absorb, attenuate, redirect, or otherwise accommodate strain caused by the expansion and/or contraction of exhaust tube 44 relative to other components such as housing 36. It should be understood that the thermally induced dimensional changes may vary relative position of at least one of first weld 110 or second weld 112 and thereby varying at least one of a size or a shape of relief opening 114. As further discussed herein, by allowing first weld 110 and/or second weld 112 to shift in response to thermal expansion and/or contraction, reduced strain that might otherwise result from rigid connections may be achieved.

Relief opening 114 may be one of a plurality of relief openings formed in support plate 72. The plurality of relief openings 114 may include at least a first relief opening 116 and a second relief opening 118. First relief opening 116 may be formed in part in first leg 84 and in part in connector portion 88, and second relief opening 118 may be formed in part in second leg 86 and in part in connector portion 88. Put differently, first relief opening 116 may extend a part of a curve distance defined by inner plate surface 106, and second relief opening 118 may extend another part of the curve distance defined by inner plate surface 106. First relief opening 116 and second relief opening 118 may be mirror images of one another. In a practical implementation, each relief opening 114 may include a slit. For instance, first relief opening 116 may include a first slit 120 formed in first leg 84, and second relief opening 118 may include a second slit 122 formed in second leg 86.

First relief opening 116 may further include a first inner relief opening edge 124 and a first outer relief opening edge 126. Second relief opening 118 may include a second inner relief opening edge 128 and a second outer relief opening edge 130. Each inner relief opening edge 124,128 may be a curvilinear inner relief opening edge and may extend along and generally parallel to a portion of curvilinear inner plate surface 106. First outer relief opening edge 126 and second outer relief opening edge 130 may each have an angular shape, at least in comparison to the curvilinear shapes of the respective inner relief opening edges 124 and 128. First inner relief opening edge 124 and second inner relief opening edge 128 may closely follow the profile of inner plate surface 106 in some embodiments. Similarly, first outer relief opening edge 126 and second outer relief opening edge 130 may generally conform to the shape of outer plate surface 108.

As suggested above, in response to increased temperatures of engine system 10, in particular in response to contact with hot exhaust, exhaust tube 44 may elongate. Exhaust tube 44 might have a coefficient of thermal expansion different than a coefficient of thermal expansion of support plate 72 and/or housing 36, or exhaust tube 44 may be more susceptible to heating based upon direct contact with hot exhaust, or both. The expansion of exhaust tube 44 may result in forces that deform inner relief opening edge 128,132 relative to outer relief opening edge 130,134, for example, translating one relative to the other. Cooling down can lead to shortening of exhaust tube 44, for example. As temperatures decrease, exhaust tube 44 may revert to a more compact configuration, with first weld 110 and second weld 112 moving closer together as exhaust tube 44 shortens.

### INDUSTRIAL APPLICABILITY

It will be recalled that exhaust tube assembly 42 includes support plate 72 having first leg 84, second leg 86, connector portion 88 bridging first leg 84 and second leg 86, and a plurality of relief openings 114, each formed in part in connector portion 88 and in part in a respective one of first leg 84 or second leg 86. Relief openings 114 may be slits 120,122, and the slits may be located between inner plate surface 106 and the outer plate surface 108.

Exhaust tube 44, together with support plate 72, may form an exhaust tube assembly 42 practical for commercial use. In a practical implementation a technician could, for instance, attach outer tube surface 60 to inner plate surface 106 through first weld 110. As mentioned above, support plate 72 could be one of a plurality of interchangeable support plates attached to exhaust tube 44 and axially spaced along the exhaust tube. With support plates 72 attached, exhaust tube 44 can then be positioned in housing 36 and secured via welding. For example, the technician could attach outer plate surface 108 to housing 36 via second weld 112. That is, the technician could proceed to weld outer plate surface 108 of each support plate 72 to first wall 46, second wall 48, and third wall 50. First mounting surface 94 and second mounting surface 96 may attach first foot 90 and second foot 92 to fourth wall 52 via a welding or fastening mechanism.

The present description is for illustrative purposes only, and should not be construed to narrow the breadth of the present disclosure in any way. Thus, those skilled in the art will appreciate that various modifications might be made to the presently disclosed embodiments without departing from the full and fair scope and spirit of the present disclosure. Other aspects, features and advantages will be apparent upon an examination of the attached drawings and appended claims. As used herein, the articles “a” and “an” are intended to include one or more items, and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. An exhaust system comprising:
a housing;
an exhaust tube forming an exhaust passage to receive a flow of exhaust;
a support plate supporting the exhaust tube in the housing, the support plate having a first leg, a second leg, and a connector portion bridging the first leg and the second leg; and
the support plate further including an inner plate surface attached to the exhaust tube, an outer plate surface attached to the housing, and a relief opening formed between the inner plate surface and the outer plate surface.

2. The exhaust system of claim 1 wherein the inner plate surface includes a curvilinear inner plate surface attached to the exhaust tube via a first weld, and the outer plate surface is attached to the housing via a second weld.

3. The exhaust system of claim 2 wherein the relief opening permits thermally induced dimensional changes varying a relative position of at least one of the first weld or the second weld.

4. The exhaust system of claim 1 wherein the relief opening is one of a plurality of relief openings formed in the support plate.

5. The exhaust system of claim 1 wherein the relief opening includes a curvilinear relief opening edge.

6. The exhaust system of claim 1 wherein the exhaust tube includes a mixing tube fluidly connected to a catalyst bank in the housing.

7. An exhaust tube assembly comprising:
an exhaust tube including an exhaust inlet located in a first tube end, an exhaust outlet located in a second tube end, and an inner tube surface forming an exhaust passage to receive a flow of exhaust;
a support plate including a first leg, a second leg, and a connector portion bridging the first leg and the second leg; and
the support plate further including an outer plate surface, an inner plate surface, and a relief opening formed between the outer plate surface and the inner plate surface.

8. The exhaust tube assembly of claim 7 wherein the inner plate surface is curvilinear and extends around a center axis defined by the exhaust tube, and the exhaust tube is attached to the inner plate surface.

9. The exhaust tube assembly of claim 8 further comprising a weld attaching the inner plate surface to the exhaust tube.

10. The exhaust tube assembly of claim 7 wherein the support plate is one of a plurality of interchangeable support plates attached to the exhaust tube and axially spaced along the exhaust tube.

11. The exhaust tube assembly of claim 7 wherein the relief opening is one of a plurality of relief openings formed in the support plate.

12. The exhaust tube assembly of claim 11 wherein the plurality of relief openings are each formed in part in each of the connector portion in a respective one of the first leg or the second leg.

13. The exhaust tube assembly of claim 11 wherein at least one of the plurality of relief openings includes a curvilinear relief opening edge.

14. The exhaust tube assembly of claim 7 wherein the first leg is connected to a first foot and the second leg is connected to a second foot, and the first foot and the second foot extend outwardly from the respective legs.

15. A support plate for an exhaust tube assembly comprising:
a support plate body including a first leg connected to a first foot, a second leg connected to a second foot, the first foot and the second foot extending outwardly from the respective legs, and a connector portion bridging the first leg and the second leg; and
the support plate body further including an outer plate surface, a curvilinear inner plate surface extending between the first foot and the second foot, and a plurality of relief openings, each extending along a part of a curve distance defined by the inner plate surface.

16. The support plate of claim 15 wherein the plurality of relief openings includes a first relief opening formed in part in the first leg and in part in the connector portion, and a second relief opening formed in part in the second leg and in part in the connector portion.

17. The support plate of claim 16 wherein the first relief opening having a first curvilinear inner relief opening edge, and the second relief opening having a second curvilinear inner relief opening edge.

18. The support plate of claim 17 wherein the outer plate surface slopes diagonally from the first leg to the connector portion and diagonally from the second leg to the connector portion.

19. The support plate of claim 15 wherein the connector portion is located at a first support plate end, and the first foot and the second foot are located at a second support plate end opposite to the first support plate end.

20. The support plate of claim 15 wherein each of the plurality of relief openings includes a slit formed between the inner plate surface and the outer plate surface.
